(19) United States
(12) Patent Application Publication
(10) Pub. No.: US 2021/0383579 A1
(43) Pub. Date: Dec. 9, 2021

(54) SYSTEMS AND METHODS FOR ENHANCING LIVE AUDIENCE EXPERIENCE ON ELECTRONIC DEVICE

(71) Applicants: Pak Kit LAM, Hong Kong (CN); Xiang YU, Auckland (NZ); Ping Tin Cuthbert LO, Sunnyvale, CA (US); Maycas Technologies Limited, Hong Kong (CN)

(72) Inventors: Pak Kit Lam, Hong Kong (CN); Xiang Yu, Auckland (NZ); Ping Tin Cuthbert Lo, Sunnyvale, CA (US)

(21) Appl. No.: 17/282,690

(22) PCT Filed: Oct. 24, 2019
(86) PCT No.: PCT/US19/57920

§ 371 Date: Apr. 2, 2021

Related U.S. Application Data
(60) Provisional application No. 62/752,642, filed on Oct. 30, 2018.

(51) Int. Cl. G06T 11/00; G06K 9/00; G06K 9/62; G06T 7/246; G06K 9/46; G06N 3/02

(52) U.S. Cl. CPC G06T 11/00; G06K 9/00718; G06K 9/6217; G06K 9/00201; G06T 2207/10016; G06K 9/4638; G06N 3/02; G06T 2207/20084; G06T 7/246

(57) ABSTRACT

Described herein are methods and systems for receiving a plurality of live video frames; identifying one or more target objects and one or more non-target objects in a first live video frame of the plurality of live video frames, by at least one trained deep neural network; identifying one or more sets of pixels belonging to the one or more target objects; identifying an area on a surface of the one or more target objects, based on the identified one or more sets of pixels belonging to the one or more target objects; overlaying one or more predetermined graphical images onto the area on the surface of the one or more target objects in the plurality of live video frames; and overlaying the one or more non-target objects onto the one or more predetermined graphical images in the plurality of live video frames to form a processed live video.

### FIELD

The present invention relates to live video streaming or broadcasting, particularly to live audience experience in video streaming or broadcasting via an electronic device.

### BACKGROUND

In a live sport game video streaming or broadcasting, not only players and game itself it streamed/broadcasted, other static objects, such as seats, stadiums, advertising boards/banners, are also shown in video scenes. Some of these static objects carry information but that is not related to audiences/viewers. For example, advertising boards/banners surrounding a soccer field in a soccer match display advertisements. The advertisements are not localized/customized to the audiences/viewers who can be from all over the world, with different demographics and different background. For example, in a live World Cup soccer match, one of the advertising boards shows an advertisement relating to Deloitte (a public accounting firm) in English. But this advertisement is not related to a high school boy from Brazil who is watching the live soccer match, and he would not be interested in it. Also, the school boy may not understand English, with the result that information/messages of the advertisement is unable to be conveyed to target audiences/viewers (in other words, the advertisements are wasted on non-target audiences/viewers). It is desirable that the content of the advertisements is tailored so that the information/messages are successfully delivered to the target audiences/viewers.

According to the known technology, audiences in different countries view different advertisements as displayed on advertising boards around edges of a soccer field during a soccer match. For example, a video containing a soccer match played in Germany is broadcasted to audiences in different countries. The advertisement (substituted advertisements) viewed by the audiences in China and Australia are different from the advertisements viewed the audiences in Germany. However, there are some limitations on applying the substituted advertisements to the video based on the known technology. In one example, an advertising board, which is adapted to display substituted advertisements, has at least one identifier. A computing system (for example, provided by a broadcasting organization) is able to recognize the advertising board as a target object based on the identifier in order for the substituted advertisement to be displayed on the target object. The identifier is considered as a predetermined criteria in order for the computing system to recognize the advertising board.

For instance, the identifier is a green screen/surface of an advertising board. When the computing system recognizes the advertising board as a target object based on the green screen/surface, the substituted advertisements are configured to be displayed on the target object. In another example, the identifier is an infrared transmitter. The advertising board includes the infrared transmitter which transmits infrared signals to cameras. Based on the infrared signals, the camera identifies the advertising board as a target object and the computing system will then arrange the substituted advertisements to be displayed on the advertising board.

Without the identifier, the computing system is unable to determine a target object, with the result that the substituted advertisements are unable to be viewed by the audiences. The present invention is able to recognize a target object by deep learning, without complying with any predetermined criteria. For instance, a video contains the advertising boards which do not include the predetermined criteria, the substituted advertisements are unable to be applied to the advertising boards. For example, 98 world cup final video (a recorded video) is available at online video sharing platforms. The video contains a plurality of advertising boards around the edges of the soccer field. However, none of the advertising boards are in green color (the predetermined criteria), with the result that substituted advertisements are unable to be applied to those advertising boards during video streaming by the user.

The present invention is directed to improved techniques for enhancing live audience experience and to providing related advantages.

### SUMMARY OF INVENTION

Example methods are disclosed herein, an example includes, at an electronic device, receiving a plurality of live video frames by an electronic device, identifying one or more target objects and one or more non-target objects in a first live video frame of the plurality of live video frames, by at least one trained deep neural network, identifying one or more sets of pixels belonging to the one or more target objects, defining an area on a surface of the one or more target objects, based the identified on one or more sets of pixels belonging to the one or more target objects, overlaying one or more predetermined graphical images onto the area on the surface of the one or more target objects in the plurality of live video frames, overlaying the one or more non-target objects onto the one or more predetermined graphical images in the plurality of live video frames to form a processed live video, wherein the processed live video comprises one or more non-target objects and the one or more predetermined graphical images overlaid on the one or more target objects.

In some examples, the one or more target objects comprises one or more static objects and the one or more non-target objects comprise one or more objects in front of the one or more static objects, wherein the one or more objects occlude the one or more static objects.

In some examples, the one or more static objects comprise one or more advertising boards.

In some embodiments, a computer readable storage medium stores one or more programs, and the one or more programs include instructions, which when executed by an electronic device, cause the electronic device to perform any of the methods described above and herein.

In some embodiments, an electronic device includes one or more processors, memory, and one or more programs, wherein the one or more programs are stored in the memory and configured to be executed by the one or more processors, the one or more programs including instructions for performing any of the methods of described above and herein.

For the aforementioned reasons, there is a need for a computing system that can efficiently display customized advertisement without requiring the advertising board to comply with any predetermined criteria. There is also a need for a computing system to customize live broadcasting of an event in accordance with various advertising requirement in real time or near-real time.

### DETAILED DESCRIPTION OF THE DRAWINGS

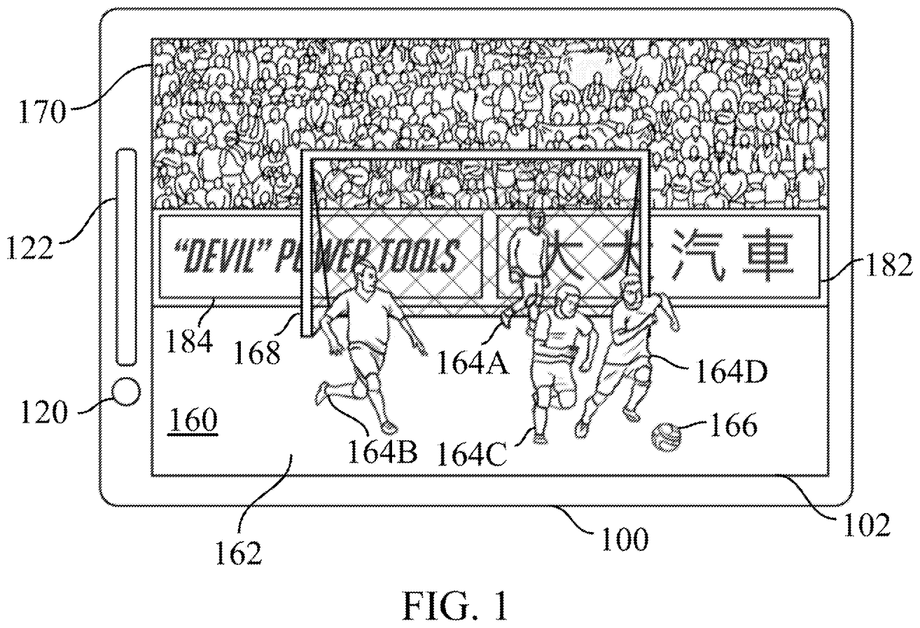

FIG. 1 depicts a screenshot of an example of a live soccer match video displayed on an electronic device in accordance with various embodiments of the present invention.

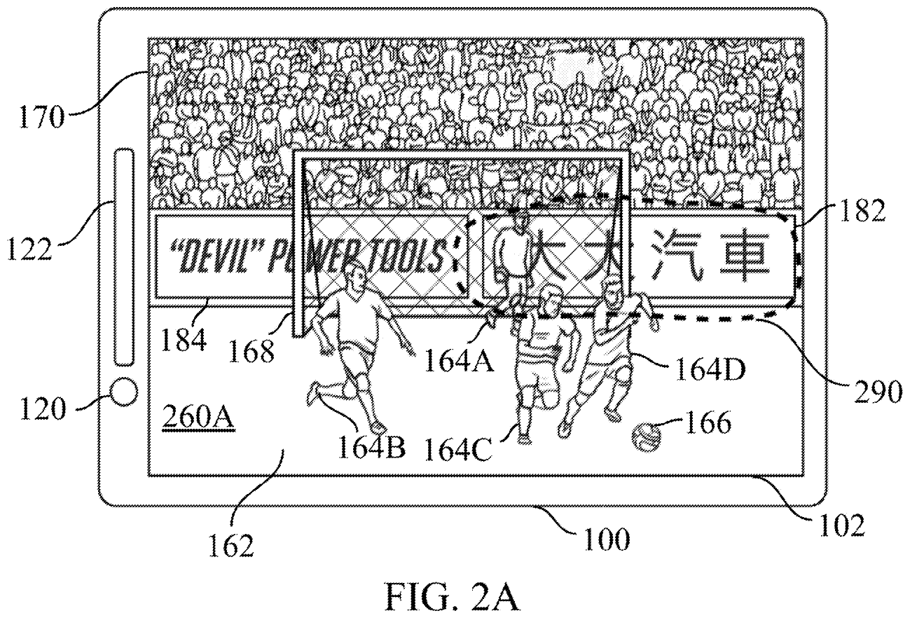

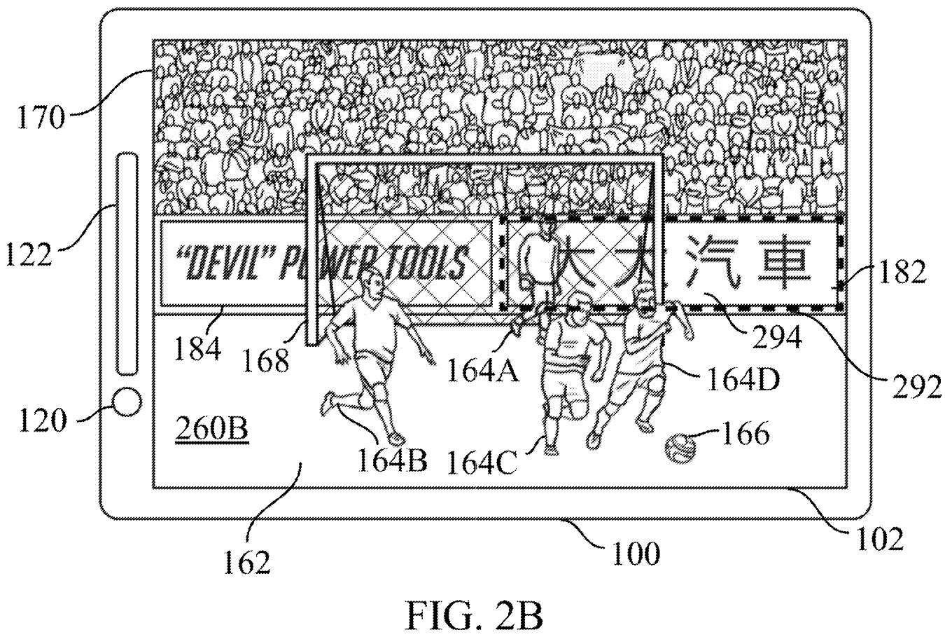

FIGS. 2A and 2B depict a schematic view of using a bounding member to determine real boundaries of a target object in accordance with various embodiments of the present invention.

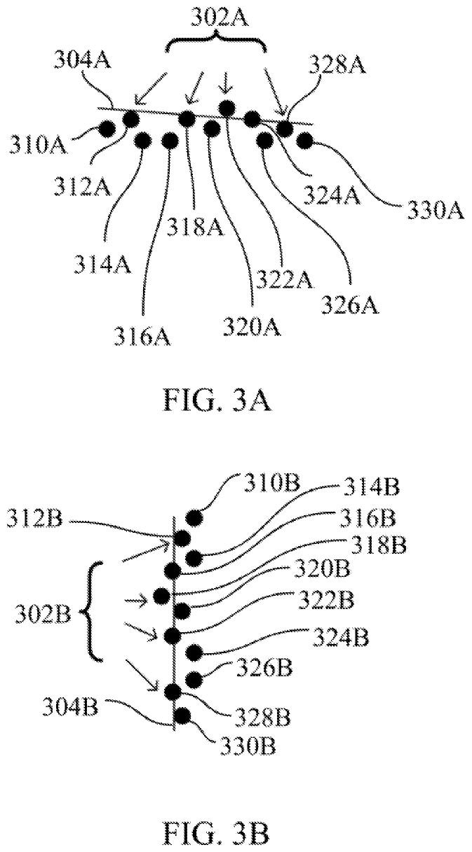

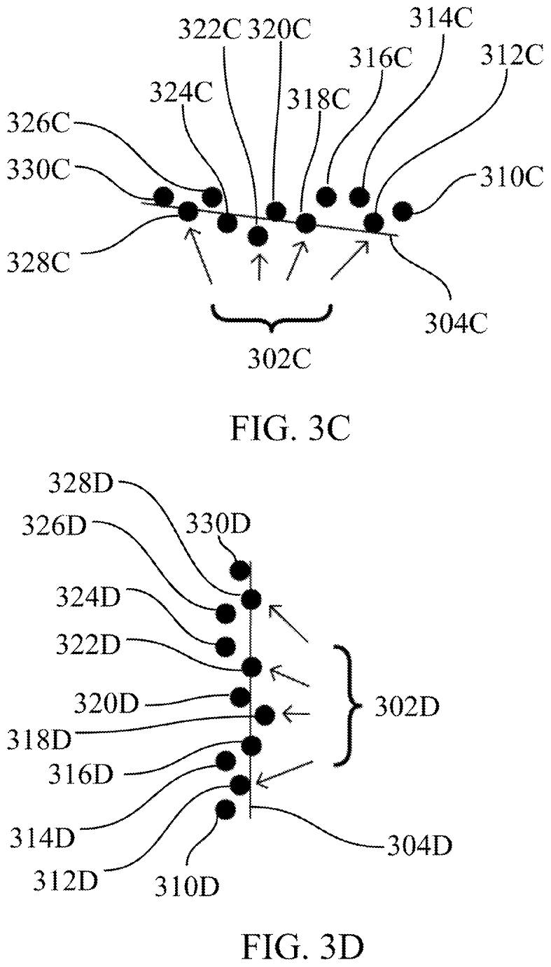

FIGS. 3A-3D depict a schematic view of a line generated based on pixels identified as extremities in accordance with various embodiments of the present invention.

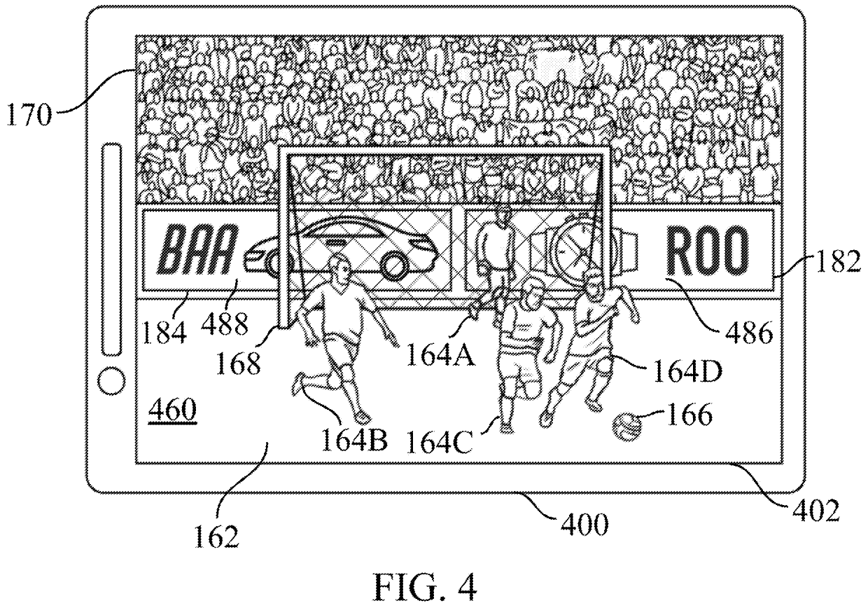

FIG. 4 depicts a screenshot of an example of a processed live soccer match video displayed on an electronic device, based on a first viewer personal information in accordance with various embodiments of the present invention.

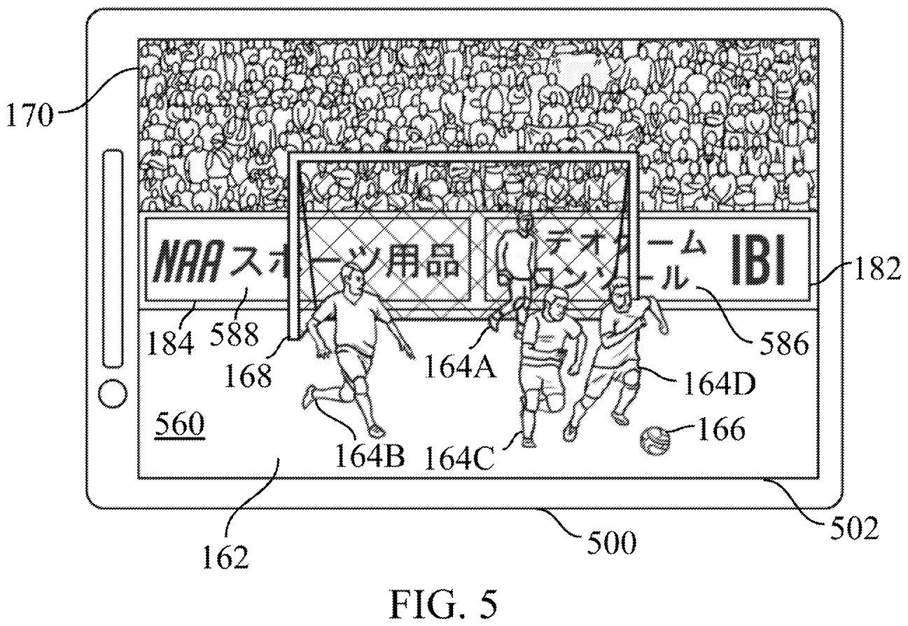

FIG. 5 depicts a screenshot of an example of a processed live soccer match video displayed on an electronic device, based on a second viewer personal information in accordance with various embodiments of the present invention.

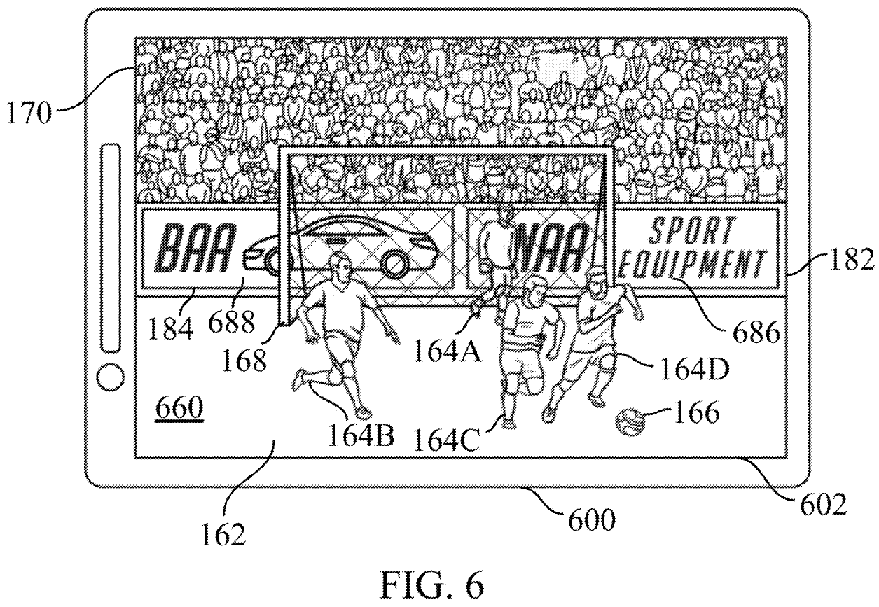

FIG. 6 depicts a screenshot of an example of a processed live soccer match video displayed on an electronic device which is located in one country in accordance with various embodiments of the present invention.

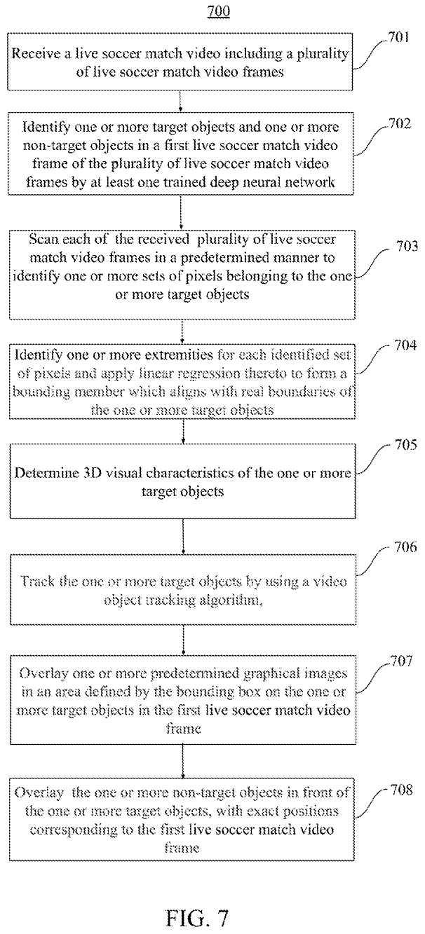

FIG. 7 depicts an example flow chart showing a process of generating a processed live soccer match video frames in accordance with various embodiments of the present invention.

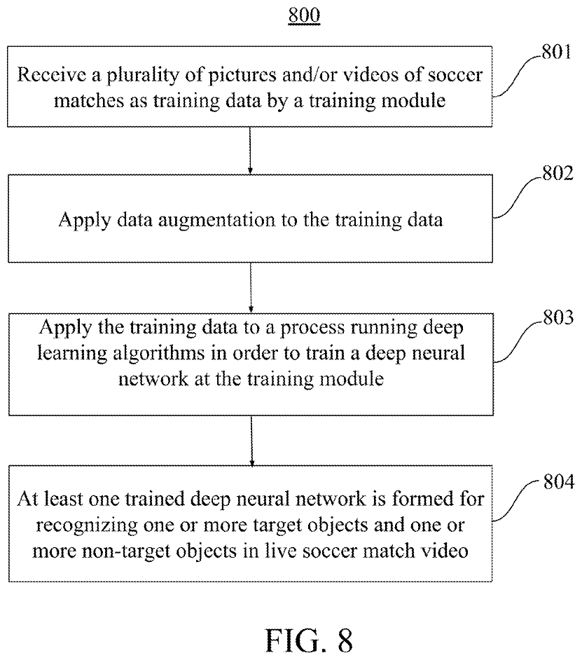

FIG. 8 depicts an example flow chart showing a process of training an electronic device to recognize target objects and non-target objects in accordance with various embodiments of the present invention.

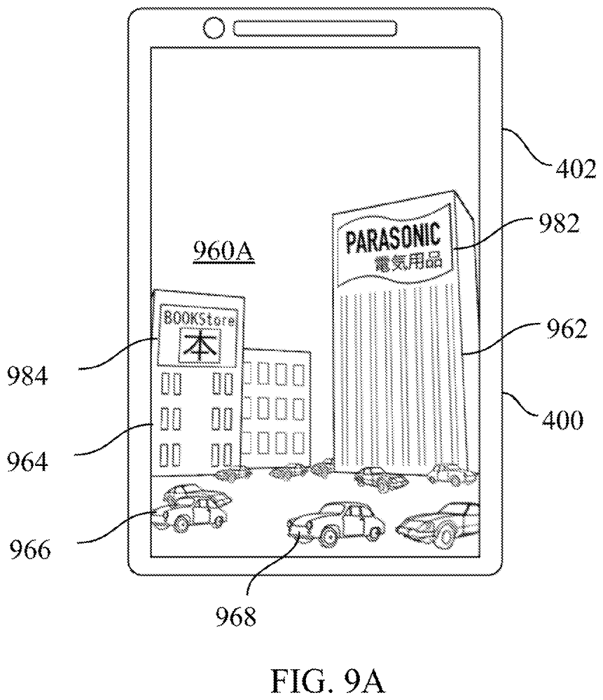

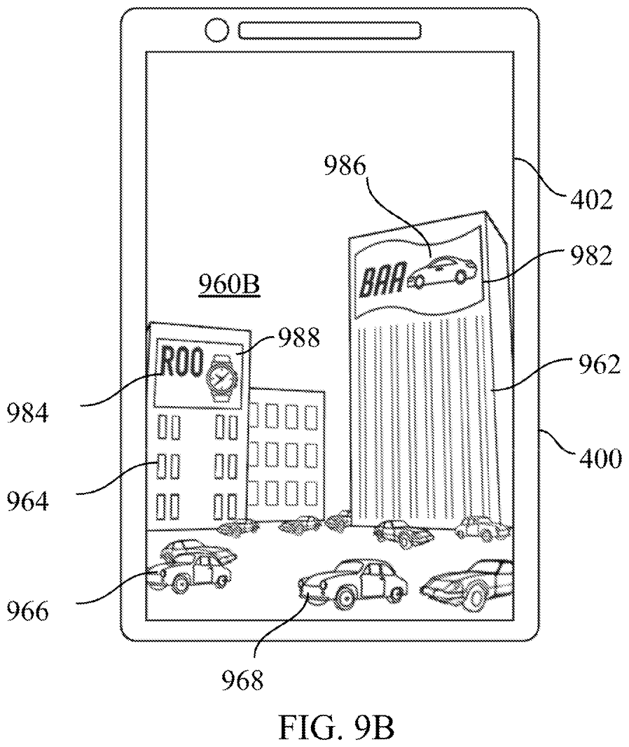

FIGS. 9A-9B depict a schematic view of a processed live video displayed on an electronic device, based on a first viewer personal information in accordance with various embodiments of the present invention.

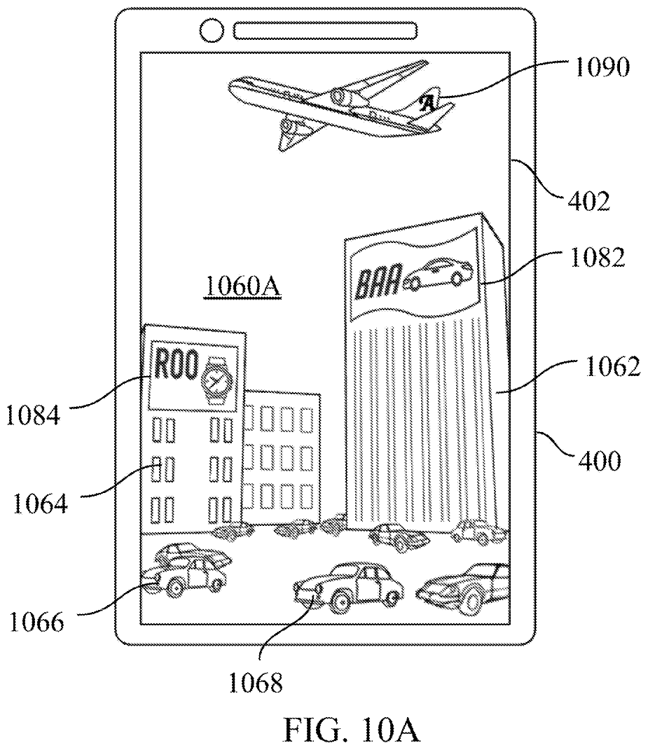

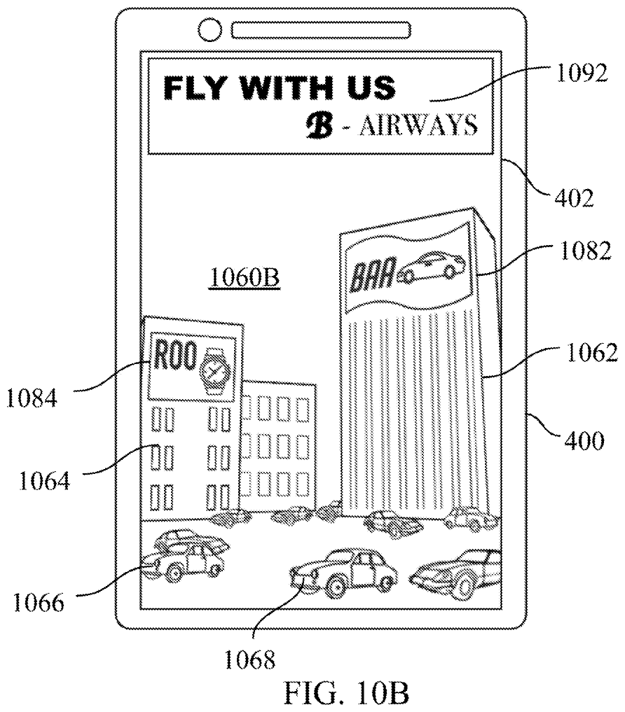

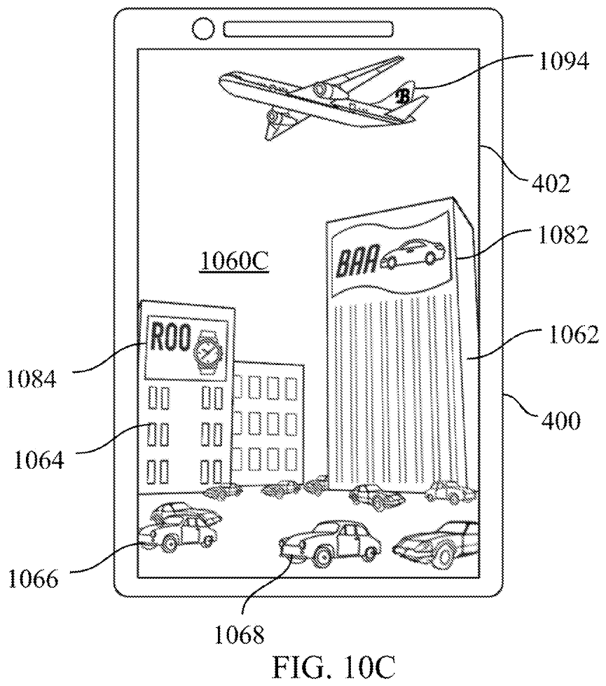

FIGS. 10A-10C depict a schematic view of a processed live video displayed on an electronic device in accordance with various embodiments of the present invention.

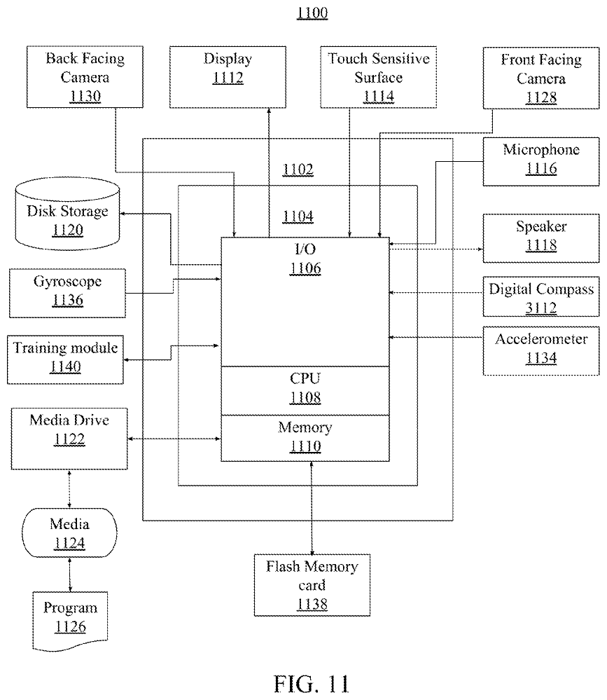

FIG. 11 depicts a computing system that may be used to implement various embodiments of the present invention.

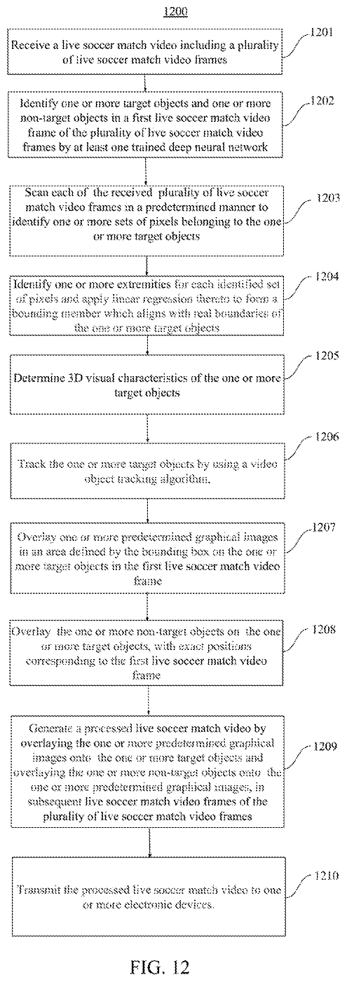

FIG. 12 depicts an example flow chart showing a process of generating a processed live soccer match video frames at a server in accordance with various embodiments of the present invention.

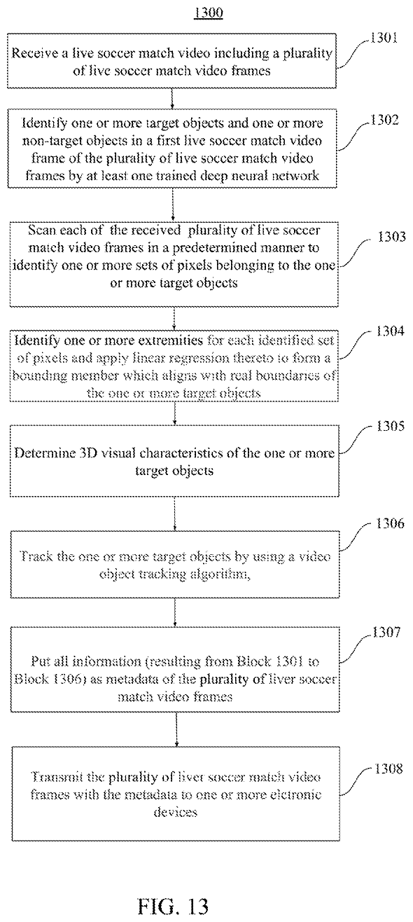

FIG. 13 depicts an alternative example flow chart showing a process of generating a processed live soccer match video frames at a sever in accordance with various embodiments of the present invention.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present invention. Thus, the disclosed invention is not intended to be limited to the examples described herein and shown, but is to be accorded the scope consistent with the claims.

Nowadays, people are able to watch a live video (i.e. for example a live sport game video) via various platforms. Some platforms are free, and some platforms are on a subscription basis such as monthly subscription fee or an annual fee. The live sport game may be a soccer match, a tennis match, an ice hockey match, a basketball match, a baseball match or any sport matches. For example, the World Cup is the globe's biggest sport event, with multiple billion people to watch the monthlong, quadrennial tournament. It is valuable time for various business entities to promote their products or services during the soccer matches. A plurality of advertising boards/banners is located around a soccer field/a soccer stadium. The plurality of advertising boards is dedicated to display advertisements for promoting various products/services. The advertisements may carry information in different languages.

FIG. 1 depicts a screenshot of an example of a live soccer match video streaming or broadcasting on an electronic device. In some examples, a viewer/an audience enjoys viewing a live soccer match video streaming/broadcasting on an electronic device such as smart device 100. Smart device 100 may be a desktop computer, a laptop computer, a smartphone, a tablet, a wearable device or a goggle. Smart device 100 is similar to and includes all or some of components of computing system 1100 described below in FIG. 9. In some embodiments, smart device 100 includes touch sensitive display 102, front facing camera 120 and speaker 122 In other examples, the electronic device may be a television, a monitor or other video displaying devices.

A live soccer match video is streamed/broadcasted to viewers via a video-recording device which is located at a soccer field/a soccer stadium. The live soccer match video streaming/broadcasting comprises a plurality of live soccer match video frames. In some examples, the viewer is allowed to view the live soccer match video on smart device 100 via a website, an application software or software programs. The website, application software or software programs may be free or be chargeable.

As depicted in FIG. 1, view 160 includes, but not limited to, soccer field 162, players 164A, 164B, 164C and 164D, soccer ball 166, goal 168, audiences 170, first and second advertising boards 182 and 184. In view 160, players 164A, 164B, 164C and 164D and goal 168 in the live soccer match video streaming/broadcasting are objects which are in front of first and second advertising boards 182 and 184 and also occlude first and second advertising boards 182 and 184 from a viewer watching the live soccer match video on smart device 100.

There is no limitation on objects displayed in the live soccer match video frames. For example, the video frames may include ten pieces of advertising boards, two goals, one soccer ball, one referee and twenty-two players, may include three pieces of advertising boards, two soccer balls, a goal and two players, may include two pieces of advertising boards and a goal or may include two pieces of advertising boards. There is no limitation on the objects which are in front of the advertising boards and also occlude the advertising boards. For example, the objects may include players 164A and 164B, soccer 166 and goal 168, may include 166 soccer and goal 168 or may include players 164C and 164D and soccer 166.

First and second advertising boards 182 and 184 are static objects in the live soccer match video. In view 160, players 164A-164D and goal 168 are in front of first and second advertising boards 182 and 184. Players 164A-164D and goal 168 occlude first and second advertising boards 182 and 184. First and second advertising boards 182 and 184 are determined as target objects by at least one trained deep neural network. Players 164A-164D and goal 168 are determined as non-target objects by the trained deep neural network. There is no limitation on positions of the advertising boards. The advertising boards may be located at any positions around the soccer field.

The trained deep neural network is obtained by feeding a plurality of pictures and/or videos of soccer matches as training data to a training module, at which a process running deep learning algorithms is performed. The training module may be located in smart device 100 or a server. In some examples, the trained deep neural network comprises a first trained deep neural network adapted to recognize one or more target objects and a second trained deep neural network adapted to recognize one or more non-target objects.

In some examples, first and second advertising content is displayed on surfaces of first and second advertising boards 182 and 184 respectively. The first advertising content relates to a car brand in Chinese and the second advertising content relates to a power tool brand in English (which are displayed on first and second advertising boards 182 and 184 in live soccer match streamed or broadcasted in real time or near-real time respectively). The live soccer match video is viewed by multiple billion viewers from different nationals. However, for non-Chinese viewers, they may not understand the first advertising content. In addition, not every viewer is interested in the power tool (second advertising content). It is desirable for first and second advertising content being suitable viewers, based on viewer preferences, viewer backgrounds or other information associated with viewers.

FIGS. 2A and 2B depict an example of using a bounding member to determine real boundaries of a target object in order for a predetermined graphical image to be overlaid thereon. In some examples, smart device 100 receives a live soccer match video. The live soccer match video comprises a plurality of live soccer match video frames. When smart device 100 identifies one or more target objects in a first live soccer match video frame of the plurality of live soccer match frames by at least one deep neural network trained by deep learning, one or more predetermined graphical images are configured to be overlaid the one or more target objects. However, the predetermined graphical images may be misaligned with the one or more target objects because real boundaries of the one or more targets are unable to be determined.

As depicted in FIG. 2A, for simplicity purposes, first advertising board 182 as a target object is described herein. View 260A is displayed on touch sensitive display 102 and includes first bounding member 290 being generated to encircle an extent of advertising board 182. Similar bounding member is also applied to second advertising board 184. First bounding member 290 may be in a ring shape, in a box shape or in any shape. First bounding member 290 is generated based on a conventional way without applying any mathematical functions thereto (such as a linear regression), with the result that first bounding member 290 does not align with real boundaries of advertising board 184 and a predetermined graphical image is unable to be aligned with advertising board when the predetermined graphical image is overlaid onto the advertising board 384.

To optimize accuracy of the bounding member, merely by way of example, smart device 100 is configured to scan the received live soccer match video frames to identify one or more sets of pixels belonging to advertising board 182 by the trained deep neural network. Based on the identified one or more sets of pixels, second bounding member 292 is formed. View 260B includes second bounding member 292 substantially aligning with real boundaries of first advertising board 182 as depicted in FIG. 2B (substantially matches the outline/shape of first advertising board 182). For example, smart device 100 scans a first live soccer match video frame of the plurality of live soccer match video frames in a predetermined sequence, for instance, from left to right, from top to bottom, from right to left and from bottom to top. Smart device 100 scans the first live soccer match video frame from top to bottom in order to determine a first set of pixels belonging to first advertising board 182 by the trained deep neural network.

There is no limitation on the predetermined sequence for scanning. For example, the predetermined sequence may be from right to left, from top to bottom, from bottom to top, from left to right. There is no limitation on scanning area. For example, smart device 100 may partially scan the first live soccer match video frame i.e. smart device 100 may scan an area of the first live soccer match video frame which contains the target objects. One of the benefits for partial scanning is to reduce computational cost as fewer pixels are scanned.

Among the first set of pixels, smart device 100 will then identify one or more pixels of the first set of pixels as extremities 302A (based on 2D coordinates) by scanning from left to right as depicted in FIG. 3A. Extremities are pixels which are in outstanding positions among neighboring pixels. At least one mathematical function will then be applied to extremities 302A to obtain line 304A. The mathematical function may take one of many forms including but not limited to a linear regression. Line 304A will correspond to a top bounding line of second bounding member 292.

Smart device 100 will then scan the first live soccer match video frame from top to bottom, from right to left and from bottom to right in order to obtain extremities 302B, 302C and 302D as depicted in FIGS. 3B, 3C and 3D respectively. A liner regression will be applied to each of extremities 302B, 302C and 302D, with the result that lines 304B, 304C and 304D are formed. Lines 304B, 304C and 304D correspond to a left bounding line, a bottom bounding line and a right bounding line of second bounding member 292 respectively.

The real boundaries of first advertising board 182 is determined, based on second bounding member 292. Second bounding member 292 defines area 294 on the surface first advertising board 182. Smart device 100 will determine 3D visual characteristics of first advertising board 182 in the original live soccer match video frames, such as perspective projection shape, lighting or any other characteristics. A predetermined graphical image is fittedly overlaid onto the area. The predetermined graphical image may include 3D visual characteristics of first advertising board 182. To make the predetermined graphical image feel like real (as if it should have been in the place in the real environment), 3D visual characteristics of the target object (first advertising board 182) are applied to the predetermined graphical image. The 3D characteristics are extracted from the target object. The 3D characteristics includes, but not limited to brightness, resolution, aspect ratio, perspective angles. Taking perspective angle and aspect ratio as an example, due to the projection of 3D object to 2D screen, a regular object in 3D may become a trapezoid, the angles and side lengths of the trapezoid are measured. The predetermined graphical image is transformed with the same angles and side lengths, i.e. the predetermined graphical image is transformed to the same trapezoid and is then fittedly overlaid onto the target object. Taking brightness as another example, the target object is divided into equal-size smaller regions. The smaller the region, the higher the resolution for brightness, but the higher the computational power is required. For each region, the brightness is estimated. One estimation method is to use OpenCV to try out a beta value of that particular region. Then the same beta value is applied to the corresponding region of the predetermined graphical image.

The shape of second bounding member 292 depends on the actual shape of the target object (advertising board 182). There is no limitation on the shape of a target object. The determination of extremities from one or more sets of pixels of the target object and the linear regression applied thereto may be used to determine real boundaries of a target object in any shape.

FIG. 4 depicts a screenshot of an example of a processed live soccer match video displayed on an electronic device, based on a first viewer personal information. Merely by way of example, a live soccer match video is received by an electronic device used such as smart device 400.

The live soccer match video comprises a plurality of live soccer match video frames. A first viewer is allowed to view the live soccer match video via smart device 400. The received live soccer match video frames will be processed at smart device 400 by displaying advertising content which may be suitable for the first viewer or in which the viewer may find interested.

In a first live soccer match video frame of the plurality of live soccer match video frames, smart device 400 will identify one or more target objects (static object(s) in the first live soccer match video frame) and one or more non-target objects (object(s) is/are in front of the static object(s) and may also occlude the static object(s) in the first live soccer match video frame) by at least one deep neural network trained by deep learning. In this case, smart device 400 determines first and second advertising boards 182 and 184 as the target objects and players 164A, 164B, 164C and 164D and goal 168 as the non-target objects, by the trained deep neural network.

As depicted in FIG. 4, view 460 is displayed on touch sensitive display 402 of smart device 400. View 460 includes soccer field 162, players 164A, 164B, 164C and 164D, soccer ball 166, goal 168, audiences 170 and first and second advertising boards 182 and 184. In this case, the first advertising content relating to a car brand in Chinese and the second advertising content relating to a power tool brand in English are replaced by first and second predetermined advertising content, based on the first viewer personal information.

Smart device 400 identifies first and second advertising boards 182 and 184 as the target objects. Second bounding member 292 will be generated to encircle each extent of advertising boards 182 and 184. Second bounding member 292 is configured to determine real boundaries of first and second advertising boards 182 and 184 and to define area 294 on each surface of first and second advertising boards 182 and 184.

When area 294 is defined on each surface of first and second advertising boards 182 and 184, first predetermined graphical image 486 and second predetermined graphical image 488 will be fittedly overlaid onto the surfaces of first and second advertising boards 182 and 184 respectively. First and second predetermined graphical images 486 and 488 belong to a plurality of predetermined graphical images stored in memory of smart device 400 or the server. Based on the first viewer personal information, first predetermined graphical image 486 and second predetermined graphical image 488 show first predetermined advertising content and second predetermined advertising content respectively. First predetermined graphical image 486 and second predetermined graphical image 488 may include 3D visual characteristics of first advertising board 182 and second advertising board 184 in the original live soccer match video frames respectively, such as perspective projection shape, lighting or any other characteristics.

Once first predetermined graphical image 486 and second predetermined graphical image 488 lie flat onto first advertising board 182 and second advertising board 184 respectively, the non-target objects will then be overlaid in front of first and second advertising boards 182 and 184, with positions identical or substantially similar to those positions in the original live soccer match video frames. Predetermined graphical images 486 and 488 will be overlaid onto advertising boards 182 and 184 and non-target objects will then be overlaid in front of advertising boards 182 and 184 in subsequent live soccer match video frames of the plurality of live soccer match video frames. In this way, any graphical images lying flat on the advertising boards look natural and feel as if those graphical images should be on the advertising boards in real world.

Once target objects in a first soccer match video frame of the plurality of live soccer match video frames (for example view 460) are identified by the trained deep neural network, the target objects are tracked by using a video object tracking algorithm. For subsequent live soccer match video frames of the plurality of live soccer match video frames, the tracked target objects are identified using the video object tracking algorithm. The trained deep neural network keeps identifying new target objects when they appear in subsequent live soccer match video frames. The video object tracking algorithm is known to a skilled person in the art. Known video object tracking algorithms, such as MedianFlow, MOSS (Minimum Output Sum of Squared Error) may be used.

One of the benefits using a video object tracking algorithm is to save neural network training cost which in terms of a collection of huge training data set and computational power. The trained deep neural network may not identify target objects in each of the plurality of live soccer match video frames. If no tracking is performed, no predetermined graphic images will be overlaid onto the target objects when the target objects are unable to be identified by the trained deep neural network in some of the plurality of live soccer match video frames. In this case, a highly accurate trained deep neural network is needed, which requires a huge training data set and strong computational power. In addition, if no tracking is performed, the real boundaries of the target objects are required to be determined in each of the plurality of live soccer match video frames (having the target object), which requires strong computational power and more processing time.

In some examples, the first viewer is allowed to pre-enter his/her personal information at a user interface or any platforms/mediums. The user interface may be provided by the website, the application software or the software programs implementing the present invention. The personal information may include age, gender, education, address, nationality, religion, professions, marital status, family members, preferred language, geographical location, salary, hobbies or any other information associated with the first viewer.

In other examples, the first viewer's personal information may also be obtained by his/her other online activities instead of pre-entering. For instance, based on his/her online shopping record, his/her preference on certain merchandises and his/her interests and hobbies can be deduced.

For example, the first personal information of the first viewer is a male, married, having one kid, 35 of age, living in San Francisco, a native English speaker, a lawyer, a movie lover and a traveler. Based on his personal information, predetermined graphical images may include advertising content relating to hi-end HIFI/home theater equipment, luxury watches, luxury cars, household products, health products, airlines and/or travel agencies. The language used in most of the predetermined advertising content is English. It is desirable for the predetermined advertising content shown on first advertising board 182 and second advertising board 184 which is closely relevant to the daily life of the first viewer. For example, first predetermined graphical image 486 may include first predetermined advertising content relating to a luxury watch brand and second predetermined graphical image 488 may include second predetermined advertising content relating to a luxury car brand. Both first and second predetermined information are in English. The first viewer is now able to view advertising content which may attract his attention (via the processed live soccer match video frames), during the live soccer match video streaming/broadcasting.

Alternatively, a live soccer match video is allowed to be processed in an electronic device such as a server. The server receives the live soccer match video from the video-recording device. The live soccer match video comprises a plurality of live soccer match video frames. The server will identify one or more target objects and one or more non-target objects in the received live soccer match video frames by the trained deep neural network, which is stored in the server. In this case, the server determines advertising boards 182 and 184 as the target objects and players 164A, 164B, 164C and 164D and goal 268 as the non-target objects.

First advertising content and second advertising content in the original live soccer match video frames will be replaced by first and second predetermined advertising content, which are shown on first and second predetermined graphical images 486 and 488 respectively, based on the first user personal information. First predetermined graphical image 486 is fittedly overlaid onto the surface of first advertising board 182. Second graphical image 488 is fittedly overlaid onto the surface of second advertising board 184. the non-target objects will then be overlaid in front of first and second advertising boards 182 and 184, with positions identical or substantially similar to those positions in the original live soccer match video frames. The processed live soccer match video image will then be transmitted to smart device 400. The first viewer is able to view the processed live soccer match video on touch sensitive display 402 of smart device 400.

In one variant, the server receives the live soccer match video from the video-recording device. The live soccer match video comprises a plurality of live soccer match video frames. The server will identify one or more target objects and one or more non-target objects in the received plurality of live soccer match video frames by using the trained deep neural network. The trained deep neural network is stored in the server. The server determines the real boundaries of the target objects, determines the 3D visual characteristics of the target objects and tracks the target objects.

Then, the server puts all this information as a meta data of the live soccer video frames and then sends the original live soccer video frames with the meta data object to a viewer device (smart device 400). Smart device 400 read the meta data object and disposes the predetermined graphical images, which stored in smart device 400, on the target objects (first and second advertising boards 182 and 184) according to the information provided by the meta data object to form a processed video. The processed video will then be displayed on smart device 400.

FIG. 5 depicts a screenshot of an example of a processed live soccer match video displayed on an electronic device, based on a second viewer personal information. In some examples, a second viewer is a male, single, living in Tokyo, 25 of age, a native Japanese speaker, a salesperson and a sport lover. A live soccer match video will be processed in an electronic device used by the second viewer to watch the live soccer match video, such as smart device 500, or other electronic devices such as a server (as mentioned above). Smart device 500 receives the live soccer match video from the video-recording device. The live soccer match video comprises a plurality of live soccer match video frames.

In a first live soccer match video frame of the plurality of live soccer match video frames, smart device 500 will identify one or more target objects (static object(s) in the first live soccer match video frame) and one or more non-target objects (object(s) is/are in front of the static object(s) and also occlude the static object(s) in the first live soccer match video frame) by at least one deep neural network trained by deep learning. In this case, smart device 500 determines advertising boards 182 and 184 as the target objects and players 164A, 164B, 164C and 164D and goal 168 as the non-target objects by the trained neural network.

As depicted in FIG. 5, view 560 is displayed on touch sensitive display 502 of smart device 500. View 560 includes soccer field 162, players 164A, 164B, 164C and 164D, soccer ball 166, goal 168, audiences 170 and first and second advertising boards 182 and 184. In this case, the first advertising content relating to a car brand in Chinese and the second advertising content relating to a power tool brand in English are replaced by first and second predetermined advertising content, based on the second viewer personal information.

Smart device 500 identifies advertising boards 182 and 184 as the target objects. Second bounding member 292 will be generated to encircle each extent of advertising boards 182 and 184. Second bounding member 292 is adapted to determine real boundaries (of first and second advertising boards 182 and 184 and to define area 294 on each surface of first and second advertising boards 182 and 184.

When area 294 is defined on each surface of first and second advertising boards 182 and 184, first predetermined graphical image 586 and second predetermined graphical image 588 will be fittedly overlaid onto the surfaces of first and second advertising boards 182 and 184 respectively. First and second predetermined graphical images 586 and 588 belong to a plurality of predetermined graphical images stored in memory of smart device 500 or the server. First predetermined graphical image 586 and second predetermined graphical image 588 show first predetermined advertising content and second predetermined advertising content respectively, based on second viewer personal information. First predetermined graphical image 586 and second predetermined graphical image 588 may include 3D visual characteristics of first advertising board 182 and second advertising board 184 in the original live soccer match video frames respectively, such as perspective projection shape, lighting or any other characteristics. In this way, any predetermined graphical images lying flat on the advertising boards look natural and feel as if those predetermined graphical images should be on the advertising boards in real world.

Once first predetermined graphical image 586 and second predetermined graphical image 588 lie flat on first advertising board 182 and second advertising board 184 respectively, the non-target objects will then be overlaid in front of first and second advertising boards 182 and 184, with positions identical or substantially similar to those positions in the original live soccer match video frames. Predetermined graphical images 586 and 588 will be overlaid onto advertising boards 182 and 184 and non-target objects will then be overlaid in front of advertising boards 182 and 184 in subsequent live soccer match video frames of the plurality of live soccer match video frames.

Based on the second viewer personal information, the predetermined graphical images may include advertising content relating to sport equipment, computers, wearable gadgets, entry level cars, travel agencies and/or social media. The language used in most of the advertising content is Japanese. It is desirable for advertising content shown on first advertising board 182 and second advertising board 184 which is closely relevant to the daily life of the second viewer. For example, first predetermined graphical image 586 may include advertising content relating to a video game brand in Japanese and second predetermined graphical image 588 may include advertising content relating to a sport equipment brand in Japanese. The second viewer is now able to view advertising content which may attract his attention (via the processed live soccer match video), during the live soccer match video streaming/broadcasting.

FIG. 6 depicts a screenshot of an example of a processed live soccer match video displayed on an electronic device based on a geographical location. In some examples, a third viewer uses smart device 600 to view the live soccer match video. Smart device 600 is positioned in the USA. Smart device 600 receives the live soccer match video from the video-recording device. The received live soccer match video will be processed in smart device 600. Alternatively, the live soccer match video is also allowed to be processed in server.

As depicted in FIG. 6, view 660 is displayed on touch sensitive display 602 of smart device 600. View 660 includes soccer field 162, players 164A, 164B, 164C and 164D, soccer ball 166, goal 168, audiences 170 and first and second advertising boards 182 and 184.

Smart device 600 will identify one or more target objects (static object(s) in the original live soccer match video frames) and one or more non-target objects (object(s) is/are in front of the static object(s) and occlude the static object(s) in the original live soccer match video frames) by at least one deep neural network trained by deep learning. In this case, smart device 600 determines advertising boards 182 and 184 as the target objects and players 164A, 164B, 164C and 164D and goal 168 as the non-target objects by the trained deep neural network.

In this case, first predetermined graphical image 686 is configured to be fittedly overlaid onto the surface of first advertising board 182. Second graphical image 688 is configured to be fittedly overlaid onto the surface of second advertising board 184. First predetermined graphical image 686 includes first predetermined advertising content and second predetermined graphical image 688 includes second predetermined advertising content. For example, first predetermined graphical image 686 may include first predetermined advertising content relating to a sport equipment in English and second predetermined may include second predetermined advertisement relating to a car brand in English.

There is no limitation on what the predetermined advertising content is included in the predetermined graphical images 686 and 688. For example, the predetermined graphical image may include advertising content relating to household products, professional services, fashion products, food and beverage products, electronic products or any products/services in English.

Turning now to FIG. 7, an example process 700 is shown for generating and providing a process live video on an electronic device. In some examples, the process 700 is implemented at an electronic device (e.g. smart device 400) having a display, one or more image sensors, in real time or near-real time. Process 700 includes receiving a live video such as a live soccer match video (Block 701). The live soccer match video is received from a video-recording device which is located at a soccer field. The live soccer match video comprises a plurality of live soccer match video frames (the original live soccer match video frames).

Smart device 400 will then determine target objects and non-target objects in a first live soccer match video frame of the plurality of live soccer match video frames. For example, the first live soccer match video frame includes soccer field 162, players 164A, 164B, 164C and 164D, soccer ball 166, goal 168, audiences 170 and first and second advertising boards 182 and 184. First and second advertising boards 182 and 184 are static objects in the original live soccer match video frames. Players 164A, 164B, 164C and 164D and goal 168 are objects in front of the static objects and also occlude the static objects.

Smart device 400 will then determine first and second advertising boards 182 and 184 as a target object and players 164A, 164B, 164C and 164D and goal 168 as a non-target object by at least one trained deep neural network (Block 702).

Smart device 400 will scan the first live soccer match video frame in a predetermined sequence, for instance from left to right, from top to bottom, from right to left and from bottom to top, in order to identify sets of pixels belonging to the target object (Block 703) by the trained deep neural network. For simplicity purposes, first advertising board 182 as the target object will be described herein. The same process is also applied to second advertising board 184.

Based on scanning from left to right, smart device 400 identifies a first set of pixels belonging to first advertising board 182 by the trained deep neural network. Among the first set of pixels, smart device 400 will then identify one or more pixels of the first set of pixels as extremities 302A, based on Y coordinate value of the pixels. For example, as depicted in FIG. 3A, when scanning from left to right, the position of pixel 312A is higher than the positions of pixels 310A and 314A (pixel 312A has greater Y coordinate value than pixels 310A and 314A) Thus, pixel 312A is identified as extremity 302A. Then, pixel 318A is identified as another extremity 302A as its position is higher than both its right and left neighboring pixels (pixels 316A and 320A). Using the same way, pixel 322A and pixel 328A are identified as the other extremities 302A. To illustrate further with a counter example, pixel 324A is not considered as extremity 302A. Although pixel 324A is higher than pixel 326A (pixel 324A has greater Y coordinate value than 326A), pixel 324A is lower than pixel 322A (pixel 324A has smaller Y coordinate value than 322A). To be identified as an extremity, the pixel has to be higher than both of its immediate neighboring pixels. A linear regression is then applied to extremities 302A to obtain first line 304A (Block 704). For a regular shape or a straight line, the linear regression may contain a formula of y=b+ax, where a and b are constants that are estimated from linear regression process. x and y are the coordinates on the image frame, i.e. the screen of a smart device or any other video player. For an irregular shape or a curved line, the linear regression may contain a formula of y=Σᵢ₌₀ⁿ aᵢxⁱ. By adjusting the value of n, the curved line can align with the boundary of the target object as close as possible. aᵢ are constants that are estimated from linear regression process.

Based on scanning from top to bottom, smart device 400 identifies a second set of pixels belonging to advertising board 182 by the trained deep neural network. Among the second set of pixels, smart device 400 will then identify one or more pixels of the second set of pixels as extremities 302B, based on X coordinate value of the pixels. For example, as depicted in FIG. 3B, when scanning from top to bottom, the position of pixel 312B is more left than the positions of pixels 310B and 314B (pixel 312B has smaller X coordinate value than pixels 310B and 314B). Thus, pixel 312B is identified as extremity 302B. Then, pixel 318B is identified as extremity 302B as its position is more left than both its upper and lower neighboring pixels (pixels 316B and 320B). Using the same way, pixel 322B and pixel 328B are identified as the other extremities 302B. To illustrate further with a counter example, pixel 316B is not considered as extremity 302B. Although pixel 316B is more left than pixel 314B (pixel 316B has smaller X coordinate value than 314B), pixel 316B is more right than pixel 318B (pixel 316B has greater X coordinate value than 318B). To be identified as an extremity, the pixel has to be more left than both of its immediate neighboring pixels. A linear regression is then applied to extremities 302B to obtain second line 304B (Block 704).

Based on scanning from right to left, smart device 400 identifies a third set of pixels belonging to advertising board 182. Among the third set of pixels, smart device 100 will then identify one or more pixels of the third set of pixels as extremities 302C, based on Y coordinate value of the pixels. For example, as depicted in FIG. 3C, when scanning from right to left, the position of pixel 312C is lower than the positions of pixels 310C and 314C (pixel 312C has smaller Y coordinate value than pixels 310C and 314C) Thus, pixel 312C is identified as extremity 302C. Then, pixel 318C is identified as another extremity 302A as its position is lower than both its right and left neighboring pixels (pixels 316C and 320C). Using the same way, pixel 322C and pixel 328C are identified as the other extremities 302C. To illustrate further with a counter example, pixel 324C is not considered as extremity 302C. Although pixel 324C is lower than pixel 326C (pixel 324C has smaller Y coordinate value than 326C), pixel 324C is higher than pixel 322C (pixel 324C has greater Y coordinate value than 322C). To be identified as an extremity, the pixel has to be lower than both of its immediate neighboring pixels. A linear regression is then applied to extremities 302C to obtain third line 304C (Block 704).

Based on scanning from bottom to top, smart device 400 identifies a fourth set of pixels belonging to advertising board 182. Among the third set of pixels, smart device 400 will then identify one or more pixels of the third set of pixels as extremities 302D, based on X coordinate value of the pixels. For example, as depicted in FIG. 3D, when scanning from bottom to top, the position of pixel 312D is more right than the positions pixels 310D and 314D (pixel 312D has greater X coordinate value than pixels 310D and 314D). Thus, pixel 312D is identified as extremity 302B. Then, pixel 318D is identified as extremity 302D as its position is more right than both its upper and lower neighboring pixels (pixels 316D and 320D). Using the same way, pixel 322D and pixel 328D are identified as the other extremities 302D. To illustrate further with a counter example, pixel 316D is not considered as extremity 302D. Although pixel 316D is more right than pixel 314D (pixel 316D has greater X coordinate value than 314D), pixel 316D is more left than pixel 318B (pixel 316D has smaller X coordinate value than 318D). To be identified as an extremity, the pixel has to be more right than both of its immediate neighboring pixels. A linear regression is then applied to extremities 302D to obtain fourth line 304D (Block 704).

Second bounding member 292 is formed based on lines 304A-304D (Block 704). Line 304A and 304C correspond to a top bounding line of second bounding member 292 and a bottom bounding line of second bounding member 292 respectively. Line 304B and 304D correspond to a left bounding line of second bounding member 292 and a right bounding line of second bounding member 292 respectively. Second bounding member 292 substantially aligns with real boundaries of first advertising board 182 (substantially matches the outline/shape of first advertising board 182). Second bounding member 292 defines area 294 on the surface first advertising board 182. Smart device 100 will determine 3D visual characteristics of first advertising board 182 in the original live soccer match video frames, such as perspective projection shape, lighting or any other characteristics (Block 705).

Once the target object (first advertising board 182) in the live soccer match video frame is identified by the trained deep neural network, the target object is tracked by using a video object tracking algorithm (block 706). For subsequent live soccer match video frames of the plurality of live soccer match video frames, the tracked target objects are identified using the video object tracking algorithm. The trained deep neural network keeps identifying new target objects when they appear in the subsequent live soccer match video frames.

Predetermined graphical image will be fittedly overlaid onto area 294, based on first viewer personal information (Block 707). In one example, a first graphical image layer containing first predetermined graphical image 486 will be overlaid onto a first target object layer containing first advertising board 182, with the result that first predetermined graphical image 486 is fittedly overlaid onto area 294 of first advertising board 182. First predetermined graphical image 486 includes 3D visual characteristics of first advertising board 182 in the original live soccer match video frames. In this way, first predetermined graphical image 486 lying flat on first advertising board 182 looks natural and feels as if first predetermined graphical image 486 should be on first advertising board 182 in real world. Block 707 will be applied to subsequent frames of the plurality of live soccer match video frames when the target objects and real boundaries thereof are determined.

Once the first graphical image layer is overlaid onto the first target object layer, a first non-target object layer containing non-target objects will be overlaid onto the graphical image layer. The non-target objects will then be positioned in front of first advertising board 182, with positions identical or substantially similar to those positions to the original live soccer match video frames (Block 708). Block 708 will be applied to subsequent frames of the plurality of live soccer match video frames when the target objects and real boundaries thereof are determined.

When Block 707 and Block 708 are applied to the plurality of the live soccer match video frames, a processed live soccer match video including first predetermined graphical image 486 lying flat on first advertising board 182 and second predetermined graphical image 488 lying flat on second advertising board 184 is formed. The first viewer is allowed to view the processed live soccer march video on touch sensitive display 402 of smart device 400 as if the first viewer watches live soccer match including first advertising board 182 in the real world displaying an advertisement of a luxury watch brand and second advertising board 184 in the real world displaying an advertisement of a luxury car brand, in real time or near-real time.

In one variant, the electronic device may be a server. The server performs process 1200 as illustrated in FIG. 12. For example, the server is allowed to perform Block 1201 to Block 1208 (which are equivalent to performing Block 701 to Block 708 of process 700). At Block 1209, the server will generate a processed live video by overlaying the one or more predetermined graphical images (first predetermined graphical image 486) onto the one or more target objects (first advertising board 182) and overlaying the one or more non-target objects onto the one or more predetermined graphical images, in subsequent frames of the plurality of live soccer match video frames. The server will then transmit the processed live soccer match video to one or more other electronic devices at Block 1210. (e.g. desktop computers, laptop computers, smart devices, monitors, televisions or any other video displaying devices) for displaying thereon.

In one variant, the server performs Block 1301 to Block 1306 of process 1300 (which are equivalent to performing Block 701 to Block 706 of process 700) as illustrated in FIG. 13. The server puts all information (resulting from Block 1301 to Block 1306) as metadata of the live soccer match video frames at Block 1307 and then sends the live soccer match video frames with the metadata to a viewer device (for example, smart device 400) at Block 1308. Smart device 400 will then apply Block 707 to Block 708 to the live soccer match video frames. The processed video will then be displayed on touch sensitive display 402 of smart device 400.

Smart device 100 or the server is pre-trained to recognize the one or more target objects and the one or more non-target objects by at least one deep neural network trained by deep learning. FIG. 8 depicts an example process 800 for training at least one deep neural network, which resides in e.g. smart device 100 or a server to recognize target objects and non-target objects in a live video (e.g. a live soccer match video). Smart device 100 or the server includes at least one training module. At Block 801, a plurality of pictures and/or videos of soccer matches as training data are received by the training module, at which at least one deep neural network is trained. The deep neural network may be a Convolutional Neural Network (CNN), or variants of CNN combined with Recurrent Neural Network (RNN) or any other forms of deep neural networks. The pictures and/or videos of soccer matches may include a plurality of video frames, in which players and goals are in front of advertising boards and also occlude the advertising boards. It is desirable for the pictures and/videos of soccer matches of the training data were taken at different perspective angles, with different backgrounds or lighting. The plurality of pictures and/or videos of soccer matches include(s), but not limited to, soccer ball, players, referees, goals, advertising boards/banners, audiences, soccer field,

At Block 802, data augmentation is applied to the received pictures and/or videos of soccer matches (training data). The data augmentation may refer to any processing on top of the received pictures and/or videos of soccer matches in order to increase diversity of the training data. For example, the training data may be flipped for getting mirror images, noise may be added to the training data or brightness of the training data may be changed. The training data will then be applied to a process running deep learning algorithms in order to train the deep neural network, at the training module at Block 803.

At Block 804, at least one trained deep neural network is formed. The trained deep neural work is adapted to recognize one or more target objects and one or more non-target objects respectively. The one or more target objects are static objects in the live soccer match video (e.g. advertising boards). The one or more non-target objects are object are in front of the one or more target objects in the live soccer match video (e.g. players and/or goals). The one or more non-target objects also occlude the one or more target objects in the live soccer match video frames. In other embodiments, the training processes can also result in a first trained deep neural network and a second trained deep neural network. The first trained deep neural network is adapted to recognize one or more target objects, and the first trained deep neural network is adapted to recognize one or more non-target objects.

The trained deep neural network will be stored in memory of smart device 100, the trained deep neural network will be used with an application software or a software program installed in smart device 100. When the application software or the software program receives a live soccer match video, the trained deep neural network is applied to the received live soccer match video in order to identify one or more target objects and one or more non-target objects in real time or near-real time.

Alternatively, the server may perform process 800 in full or may partially perform process 800. For example, the server is allowed to perform Block 801 to Block 804. The server will then transmit the trained deep neural network to one or more other electronic devices (e.g. desktop computers, laptop computers, smart devices or televisions) for recognizing target objects and non-target objects.

For illustrative purposes only, a video streaming or broadcasting contains some content that may not be suitable for every audience, may not be understood by every audience or may not attract every audience. FIG. 9A depicts a screenshot of an example of a video streaming or broadcasting displayed on an electronic device. In some examples, the first user of FIG. 4 views a video (the video may be a live video or a recorded video) on touch sensitive display 402 of smart device 400. There is no limitation on the source of the video. The video may be provided by TV companies, online video-sharing platforms, online social media networks or any other video producers/video sharing platforms. For instance, the first user views a video from an online video-sharing platform. The video comprises a plurality of video frames. As depicted in FIG. 9A, view 960A is displayed on touch sensitive display 402 and includes smart device 400 being trained to recognize one or more target objects in the plurality of video frames by deep learning. In some examples, billboards/advertising boards located at buildings are considered as target objects. Smart device 400 includes at least one training module, at which at least one deep neural network (for recognizing the billboards/advertising boards) is trained by feeding a plurality of pictures and a plurality of videos containing billboards/advertising boards located at buildings. The trained deep neural network will be stored in smart device 400. Based on the trained deep neural network, smart device 400 is able to recognize first and second billboards 982 and 984 located at buildings as the target objects. For objects other than the target objects, smart device 400 will consider them as non-target objects.

Views 960A includes target objects (such as first and second billboards 982 and 984) and non-target objects (such as buildings 962 and 964 and vehicles 966 and 968). First billboard 982 contains advertising content associated with a Japanese electrical appliance manufacturer and second billboard 984 contains advertising content associated with a Japanese book store. Smart device 400 includes the trained deep neural network, through which smart device 400 is able to recognize billboards/advertising boards (target objects) in the plurality of video frames. Smart device 400 will then perform the one or more processes mentioned above.

FIG. 9B depicts a screenshot of an example of a processed video resulting from predetermined images being overlaid onto the video frames of FIG. 9A based on a user of personal information. As depicted in FIG. 9B, by performing the processes mentioned above, view 960B is displayed on display 402 and includes first predetermined graphical image 986 and second predetermined graphical image 988 being fittedly overlaid onto billboards 982 and 984 respectively, based on the first user personal information.

First predetermined graphical image 986 includes first predetermined advertising content relating to a luxury car brand and second predetermined graphical image 988 includes second predetermined advertising content relating to a luxury watch brand. A second graphical image layer containing first and second predetermined graphical images 986 and 988 is overlaid onto a second target object layer containing billboards 982 and 984. A second non-target layer containing the non-target objects (such as buildings 962 and 964 and vehicles 966 and 968) is overlaid onto the second graphical image layer. By overlaying multiple of layers in the plurality of the vide frames in real time or near-real time, a processed video is formed.

FIG. 10A is a screenshot of another example of a video streaming or broadcasting containing one or more target objects. In one embodiment, smart device 1000 is trained to recognize one or more target objects by deep learning. The target object is airplane 1090 (under A-Airline) in a video (the video may be a live video or a recorded video). Smart device 400 includes at least one trained deep neural network associated with the target object in memory. The first user of FIG. 4 uses smart device 400 to enjoy video streaming or broadcasting. For instance, the first user views the video from an online video-sharing platform. The video comprises a plurality of video frames. As depicted in 10A, view 1060A includes a target object (airplane 1090) and other non-target objects such as buildings 1062 and 1064, vehicles 1066 and 1068, billboard/advertising boards 1082 and 1084. In some examples, an airplane is considered as a target objects. Smart device 400 includes at least one training module, at which at least one deep neural network (for recognizing the airplane) is trained by feeding a plurality of pictures and a plurality of videos containing airplanes. The trained deep neural network will be stored in smart device 400. Based on the trained deep neural network, smart device 400 is able to recognize airplane 1090 in the sky as the target object. For objects other than the target object, smart device 400 will consider them as non-target objects.

Smart device 400 includes the trained deep neural network, through which smart device 400 is able to recognize airplane 1090 in the plurality of live video frames. Smart device 400 will then perform the one or more processes mentioned above.

FIG. 10B depicts a screenshot of an example of a processed video resulting from predetermined images being overlaid onto the live video frames of FIG. 10A. As depicted in FIG. 10B, view 1060B includes predetermined graphical image 1092 being overlaid onto the target object (airplane 1090) and the non-target objects, by performing the processes mentioned above. Predetermined graphical image 1092 includes first predetermined advertising content relating to B-Airline. A third graphical image layer containing predetermined graphical image 1092 is overlaid onto a third target object layer containing airplane 1090. A third non-target layer containing the non-target objects (such as buildings 1062 and 1064, vehicles 1066 and 1068, billboard/advertising boards 1082 and 1084) is overlaid onto the third graphical image layer. By overlaying multiple of layers in the plurality of the video frames in real time or near-real time, a processed video is formed.

In one variant, the target object is replaced by a predetermined graphical image, which is in the same nature as the target object. FIG. 10C depicts a screenshot of an example of a processed video resulting from predetermined images being fittedly overlaid onto the live video frames of FIG. 10A. As depicted in FIG. 10C, view 1060C includes predetermined graphical image 1094 (including an airplane under B-Airline) being fittedly overlaid onto the target object (airplane 1090 under A-Airline) and the non-target objects, by performing the processes mentioned above. A fourth graphical image layer containing predetermined graphical image 1094 is overlaid onto a fourth target object layer containing airplane 1090. A fourth non-target layer containing the non-target objects (such as buildings 1062 and 1064, vehicles 1066 and 1068, billboard/advertising boards 1082 and 1084) is overlaid onto the fourth graphical image layer. By overlaying multiple of layers in the plurality of the video frames in real time or near-real time, a processed video is formed (as if airplane under B-Airline appears in the video streaming/broadcasting).

Turning now to FIG. 11, components of an exemplary computing system 1100, configured to perform any of the above-described processes and/or operations are depicted. For example, computing system 1100 may be used to implement smart device 100 described above that implements any combination of the above embodiments or processes 700 and 800 described with respect to FIG. 7 and FIG. 8. Computing system 1100 may include, for example, a processor, memory, storage, and input/output peripherals (e.g., display, keyboard, stylus, drawing device, disk drive, Internet connection, camera/scanner, microphone, speaker, etc.). However, computing system 1100 may include circuitry or other specialized hardware for carrying out some or all aspects of the processes.

In computing system 1100, main system 1102 may include motherboard 1104, such as a printed circuit board with components mount thereon, with a bus that connects input/output (I/O) section 1106, one or more processors 1108, and memory section 1110, which may have flash memory card 1138 related to it. Memory section 1110 may contain computer-executable instructions and/or data for carrying out processes 700 and 800 or any of the other processes described herein. I/O section 1106 may be connected to display 1112 (e.g., to display a view), touch sensitive surface 1114 (to receive touch input and which may be combined with the display in some cases), microphone 1116 (e.g., to obtain an audio recording), speaker 1118 (e.g., to play back the audio recording), disk storage unit 1120, media drive unit 1122. Media drive unit 1122 can read/write a non-transitory computer-readable storage medium 1124, which can contain programs 1126 and/or data used to implement processes 700 and 800 or any of the other processes described above.

Additionally, a non-transitory computer-readable storage medium can be used to store (e.g., tangibly embody) one or more computer programs for performing any one of the above-described processes by means of a computer. The computer program may be written, for example, in a general-purpose programming language (e.g., Pascal, C, C++, Java, or the like) or some specialized application-specific language.

Computing system 1100 may include various sensors, such as front facing camera 1128 and back facing camera 1130. These cameras can be configured to capture various types of light, such as visible light, infrared light, and/or ultra violet light. Additionally, the cameras may be configured to capture or generate depth information based on the light they receive. In some cases, depth information may be generated from a sensor different from the cameras but may nonetheless be combined or integrated with image data from the cameras. Other sensors or input devices included in computing system 1100 include digital compass 972, accelerometer 1134 and gyroscope 1136. Other sensors and/or output devices (such as dot projectors, IR sensors, photo diode sensors, time-of-flight sensors, etc.) may also be included.

While the various components of computing system 1100 are depicted as separate in FIG. 9 various components may be combined together. For example, display 1112 and touch sensitive surface 1114 may be combined together into a touch-sensitive display.

In one variant, computing system 1100 may be used to implement a sever described above that implements any combination of the above embodiments or processes 700 and 800 described with respect to FIG. 7 and FIG. 8. The server may include, for example, a processor, memory, storage, and input/output peripherals. In the server, main system 1102 may include motherboard 1104, such as a printed circuit board with components mount thereon, with a bus that connects input/output (I/O) section 1106, one or more processors 1108, and memory section 1110, which may have flash memory card 1138 related to it. Memory section 1110 may contain computer-executable instructions and/or data for carrying out processes 700 and 800 or any of the other processes described herein. Media drive unit 1122 can read/write a non-transitory computer-readable storage medium 1124, which can contain programs 1126 and/or data used to implement processes 700 and 800 or any of the other processes described above.

Additionally, non-transitory computer-readable storage medium can be used to store (e.g., tangibly embody) one or more computer programs for performing any one of the above-described processes by means of a computer. The computer program may be written, for example, in a general-purpose programming language (e.g., Pascal, C, C++, Java, or the like) or some specialized application-specific language.

Various exemplary embodiments are described herein. Reference is made to these examples in a non-limiting sense. They are provided to illustrate more broadly applicable aspects of the disclosed invention. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features which may be readily separated from or combined with the features of any of the other several embodiments without departing from the scope or spirit of the various embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

1. A method comprising:
receiving a plurality of live video frames by an electronic device;
identifying one or more target objects and one or more non-target objects in a first live video frame of the plurality of live video frames, by at least one trained deep neural network;
identifying one or more sets of pixels belonging to the one or more target objects;
defining an area on a surface of the one or more target objects, based on the identified one or more sets of pixels belonging to the one or more target objects;
overlaying one or more predetermined graphical images onto the area on the surface of the one or more target objects in the plurality of live video frames; and
overlaying the one or more non-target objects onto the one or more predetermined graphical images in the plurality of live video frames to form a processed live video, wherein the processed live video comprises one or more non-target objects and the one or more predetermined graphical images overlaid on the one or more target objects.

2. The method of claim 1, wherein the one or more target objects comprises one or more static objects.

3. The method of claim 2, wherein the one or more non-target objects comprise one or more objects in front of the one or more static objects, wherein the one or more objects occlude the one or more static objects.

4. The method of claim 3, wherein the one or more static objects comprise one or more advertising boards.

5. The method of claim 1, further comprising:
scanning the first live video frame of the plurality of live video frames in a predetermined sequence to identify the one or more sets of pixels belonging to the one or more target objects.

6. The method of claim 5, further comprising:
identifying one or more extremities corresponding to each of the identified one or more sets of pixels belonging to the one or more target objects;
applying at least one mathematical function to the identified one or more extremities to form one or more lines.

7. The method of claim 6, further comprising:
generating a bounding member based on the one or more lines resulting from the at least one mathematical function, wherein the boundary member substantially aligns with real boundaries of the one or more target objects and defines the area.

8. The method of claim 6, where in the at least one mathematical function is a linear regression.

9. The method of claim 1, further comprising:
determining 3D visual characteristics of the one or more target objects.

10. The method of claim 1, further comprising:
tracking the one or more target objects by a video object tracking algorithm.

11. The method of claim 1, further comprising:
displaying the processed live video on a display of the electronic device or a display of another electronic device in real time or near-real time.

12. The method of claim 1, wherein the at least one trained deep neural network comprises convolutional neural network (CNN) or variant of CNNs, and/or combined with recurrent neural network (RNN).

13. A computer readable storage medium storing one or more programs, the one or more programs comprising instructions, which when executed by an electronic device with a display, cause the electronic device to perform method of claim 1.

14. An electronic device, comprising:
one or more processors;
at least one display;
a memory; and
one or more programs, wherein the one or programs are stored in the memory and configured to be executed by the one or more processors, the one or more programs including instructions for preforming the method of claim 1.
